(19) United States
(12) Patent Application Publication
(10) Pub. No.: US 2010/0332316 A1
(43) Pub. Date: Dec. 30, 2010

(54) System and Method for Transacting with an Advertising Agency Participating on an Advertising Exchange

(76) Inventors: David Chaiken, Menlo Park, CA (US); Dirk Reinshagen, San Mateo, CA (US); Venkatesh B. Natrajan, San Jose, CA (US); Robert van Gent, Redwood City, CA (US); Sundar Seshadri, Santa Clara, CA (US); Raymond P. Stata, Atherton, CA (US)

Correspondence Address: Stattler-Suh PC, 60 SOUTH MARKET, SUITE 480, SAN JOSE, CA, 95113, US

(21) Appl. No.: 12/495,047

(22) Filed: Jun. 30, 2009

(51) Int. Cl. G06Q 30/00

(52) U.S. Cl. 705/14.46; 705/14.4; 705/14.69; 705/14.7; 705/14.71

(57) ABSTRACT

A method and system for transacting with an agency participating on an advertising exchange network for serving online advertisements. An advertising exchange agency may serve multiple roles in the advertising exchange network. The method includes storing a machine-readable representation of a plurality of network entities in a directed graph representation. Network configurations codified in directed graph representations include the identification of at least one agency that participates on the advertising exchange as well as identification of at least one network entity that does not participate on the advertising exchange, thus providing a buyer-seller online advertising marketplace. Servers are configured for transmitting an opportunity to serve an online advertisement to the advertising exchange network, and one or more network entities are configured to deliver the online advertisement. Financial transactions including revenue sharing payments to the agency are managed by traversing the network representation through one or more paths including the agency.

### FIELD OF THE INVENTION

The present invention is related to the field of exchange ad delivery systems and is more specifically directed to methods for agency interactions on the exchange.

### BACKGROUND OF THE INVENTION

Electronic exchanges, including online auctions, have proliferated along with the Internet. These electronic exchanges aim to provide a high degree of trading efficiency by bringing together a large number of buyers and sellers. Such centralized exchanges are focused on directly matching the bids and offers of buyers and sellers. Conventional transactions on the exchange are between (i) buyers and sellers, (ii) intermediaries (e.g. brokers, which may be a buyer or seller), or (iii) buyers or sellers and intermediaries.

The proliferation of Internet activity has also generated tremendous growth in advertising on the Internet. Typically, advertisers (e.g. buyers of ad space) and online publishers (sellers of ad space) have agreements with one or more advertising networks (ad-networks), which provide for serving an advertiser's banner or ad across multiple publishers, and concomitantly provide for each publisher having access to a large number of advertisers. Ad-networks, which may also manage payment and reporting, may also attempt to target certain Internet users with particular advertisements to increase the likelihood that the user will take an action with respect to the advertisement.

In some cases, online advertising markets exhibit undesirable inefficiencies when buyers and sellers are unable to transact. For instance, although a publisher may be subscribed to many ad-networks, and one or more of those ad-networks may transact inventory with other ad-networks, it might be that only one of the ad-networks to which the publisher is subscribed is involved in selling (e.g. auctioning) a given ad space for the publisher. One approach is to allow an intermediary (e.g. an agency) into the ecosystem, where that intermediary is suited to find, select, and prioritize the inventory of ad calls on behalf of the agency's client.

In the reverse it happens that in some cases although an advertiser may be subscribed to many ad-networks, and one or more of those ad-networks may transact advertising placements with other ad-networks, it might be that only one of the ad-networks to which the advertiser is subscribed is involved in bidding (e.g. auctioning) a given ad for the advertiser. Again, one approach is to allow an intermediary (e.g. an agency) into the ecosystem, where that intermediary is suited to find, select, and prioritize ad placements on behalf of the agency's client.

In both of the above cases, the needed ecosystem might include an agency: The mere existence of any agency functioning as an additional intermediary demands new semantics and new methods for transacting business. What is needed is a system for establishing advertising demand/supply interrelationships in a low-cost, flexible, and dynamic manner. Thus, embodiments of the invention disclosed herein provide methods for transacting business on the exchange, while supporting the traditional business-to-business role of an agency and roles of the agency's staff.

Other automated features and advantages of the present invention will be apparent from the accompanying drawings and from the detailed description that follows below.

### SUMMARY OF THE INVENTION

A method and system for transacting with an advertising agency participating on an advertising exchange network for serving online advertisements. An advertising exchange agency may serve multiple roles in the advertising exchange network-in some cases as a pure agency, in some cases as a reseller, and in some cases as one of many agencies involved in a transaction. The method includes storing a machine-readable representation of a plurality of network entities in a directed graph representation. Network configurations codified in directed graph representations include the identification of at least one agency that participates on the advertising exchange as well as identification of at least one network entity that does not participate on the advertising exchange, thus providing a common buyer-seller marketplace for online advertisements. The system includes servers configured for transmitting an opportunity to present an online advertisement to the advertising exchange network. One or more network entities are configured to deliver the online advertisement. Financial transactions, including revenue sharing payments to the agency, are managed by traversing the network representation through a path from buyer to seller.

### BRIEF DESCRIPTION OF THE DRAWINGS

A brief description of the drawings follows:

FIG. 1A shows an advertising network environment, depicted as a directed graph, in which some embodiments operate.

FIG. 1B shows an advertising network environment, showing a path from a buyer to a seller, in which some embodiments operate.

FIG. 1C shows an advertising network environment, showing a path from a buyer to a seller through an intermediary, in which some embodiments operate.

FIG. 2A shows advertising network environments, each showing a path from a buyer to a seller through an intermediary, in which some embodiments operate.

FIG. 2B shows advertising network environments, each showing a path from a buyer to a seller through an intermediary, and including a representation of contracts, in which some embodiments operate.

FIG. 2C shows advertising network environments, each showing a path from a buyer to a seller through an intermediary, and including a representation of contracts and access rules, in which some embodiments operate.

FIG. 3 shows an advertising network environment showing buyers and sellers working with a pure agency intermediary, in which some embodiments operate.

FIG. 4 shows an advertising network environment showing buyers and sellers working with an agency who is a reseller, in which some embodiments operate.

FIG. 5 shows an advertising network environment showing buyers and sellers working with an agency intermediary, in which some embodiments operate.

FIG. 6 shows an advertising network environment showing buyers and sellers working with an agency, in which some embodiments operate.

FIG. 7 shows an advertising network environment showing buyers and sellers working with an agency as an aggregator, in which some embodiments operate.

FIG. 8 shows an advertising network environment showing paths from buyers to sellers, including intermediaries, in which some embodiments operate.

FIG. 9 is a chart showing agency attributes over a series of agency scenarios, according to one embodiment.

FIG. 10 is a diagrammatic representation of a machine in the exemplary form of a computer system, within which a set of instructions for causing the machine to perform any one of the methodologies discussed herein may be executed.

FIG. 11 is a diagrammatic representation of several computer systems in the exemplary environment of a multi-server network, within which environment a communications protocol may be executed.

FIG. 12 is a diagrammatic representation of two computer systems in the exemplary environment of a two-server network, within which environment a communications protocol may be executed.

FIG. 13 is a diagrammatic representation of several computer systems in the exemplary form of a server network, within which environment a communications protocol may be executed.

FIG. 14 is a flow chart showing operations for a method for transacting with an advertising agency participating as a seat-holder on an advertising exchange, according to one embodiment.

FIG. 15 is a flow chart showing operations for a method for transacting with two advertising agencies, each participating as a seat-holder on an advertising exchange, according to one embodiment.

### DETAILED DESCRIPTION

In the following description, numerous details are set forth for purpose of explanation. However, one of ordinary skill in the art will realize that the invention may be practiced without the use of these specific details. In other instances, well-known structures and devices are shown in block diagram form in order to not obscure the description of the invention with unnecessary detail.

Some embodiments of the invention include an exchange. More specifically, descriptions of embodiments of the invention involve concepts and descriptions of network entities, agency, agency-on-exchange, agency-within-ad-network, agency-as-ad-network, contracts, links, and revenue sharing. More still, descriptions of embodiments of the invention involve (a) shared or otherwise controlled access to data that allows an agency-on-exchange to proxy for the agency's client, and (b) billing practices.

Further, the foregoing allows new categories of entities to conduct business within the context of an ad platform, with required functionalities, protections, and billing and reporting systems. These features are further described below.

### Agency Overview

Agencies as discussed herein include real companies with real people making decisions and taking action on behalf of the agency's clients. Agencies can enter into business deals with other entities on the exchange. Using the techniques described herein, an agency's business deals (i.e. contracts) can be represented as data items to be shared among the entities involved in a given transaction. Further, agencies seek and establish contracts with other entities on the exchange. As used within the context of the embodiments of the invention herein, these contracts allow agencies to: (a) be granted access to certain ad-network-related data pertaining to their client's accounts, (b) optionally specify a revenue sharing model for remuneration, and (c) act as a proxy for any invoicing and payments on behalf of their customers. Embodiments of the invention herein provide for representing an agency as an entity on the exchange, and thus, as an entity-on-exchange, the agency may participate with the exchange (i.e. perform transactions through or with other exchange seat-holders).

Other embodiments provide for agencies to perform regular advertising and publishing activities on the exchange within the limits of permissions granted to the agency specifically for the purpose of performing such activities. Such agency activities are often performed on behalf of the agency's clients.

### Definitions and Depiction of Exchange: Network Graphs, Directed Graphs

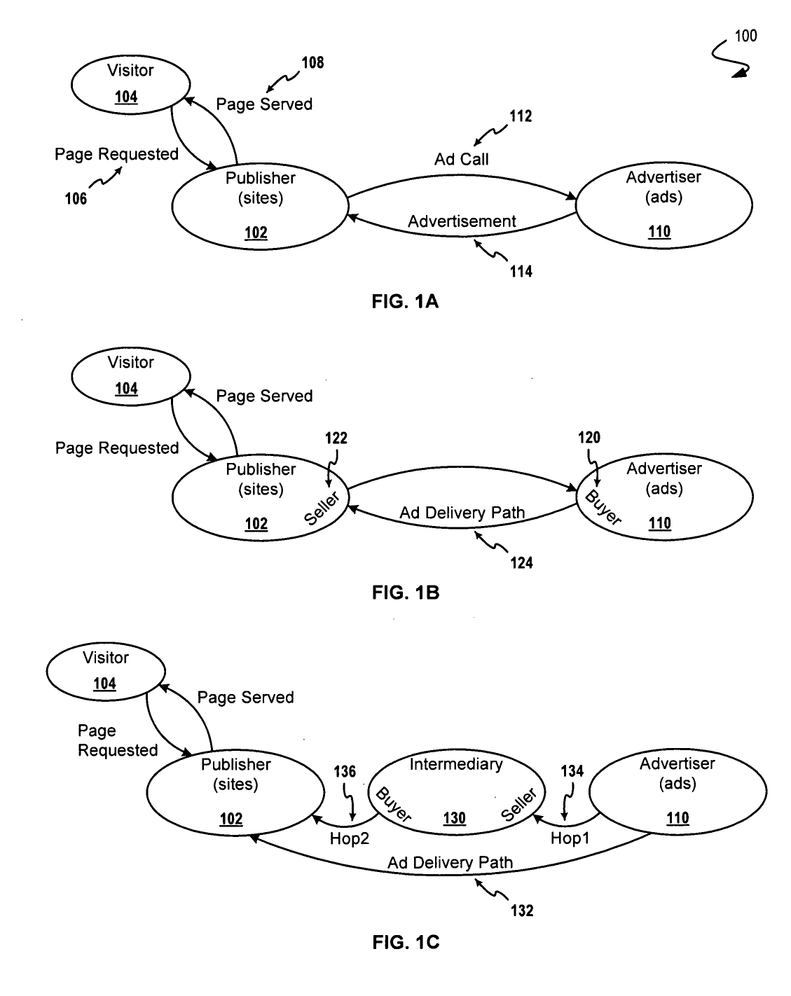

FIG. 1A shows an advertising network environment depicted as a directed graph wherein a publisher 102 of a site engages in serving pages to a web page visitor 104 (page requested 106, page served 108). Also shown is a publisher's interaction with an advertiser 110. In this simplified model, a visitor requests a page from the publisher 102. The publisher performs an ad call 112 to an advertiser, and the advertiser in turn supplies an advertisement 114 to the publisher. The page requested by the visitor is composited to include the advertisement, and the requested page is served to the visitor.

FIG. 1B shows the graph of FIG. 1A, and includes labeling of the source node (buyer 120) and destination node (seller 122) pertaining to the graph edge labeled as ad delivery path 124 which ad delivery path generally begins with a buyer and ends with a seller.

FIG 1C shows an advertising network environment including an intermediary 130. In this environment, the intermediary acts as both a buyer and seller. As shown, the ad delivery path 132 begins with the advertiser, and ends with the publisher as in FIG. 1A and FIG. 1B, and in this case, the ad delivery path is accomplished via two hops, hop1 134 and hop2 136.

So, with the above definitions, and for the purposes of understanding the disclosure herein, an ad delivery transaction on the exchange can be represented on a directed graph such as is shown in FIG. 1A, FIG. 1B, and FIG. 1C. For each ad delivery transaction the following assertions hold true:
An ad delivery transaction originates from an entity (buyer) and terminates at an entity (seller). The directed edge is referred to as a hop. One or more hops between graph nodes is a path.
A path may traverse through zero or more other nodes (e.g. entities) on the exchange, each such node is considered to be an intermediary in the transaction.
A path may comprise several sub-paths or hops; each hop has a buyer end-point at the beginning (an entity) and a seller end-point (another entity) at the end.
The buyer end-point of the first such hop is termed the original buyer in the ad delivery transaction.
The seller end-point of the last hop is termed the original seller.
The transactions accomplished between the original seller and the original buyer are termed ad delivery transactions.

Now, for any ad delivery transaction, there may be zero, one, or more hops, and as introduced above, each hop has a buyer and a seller and may also have an intermediary or agency. Accordingly, a hop represents a transactional relationship between a buyer and a seller, even if not the original buyer and original seller. Such relationships may include a link, and possibly also a deal. Collectively these relationships as represented on the directed graph are known as links and deals.

### Agency Role and Actions on the Exchange

Agencies are entities on the exchange that perform activities on behalf of their customers. These activities include actions to:
Place orders
Manage campaigns
Create ads

Manage links
Manage deals
Manage sites
View and interpret reports
Participate in billing and payment.

As are described in exemplary embodiments, an agency may operate as a reseller, under which model an agency gets billed by its supplier(s), and in turn bills its customers for delivery. In the reverse sense of a reseller, an agency gets paid by its customer, and in turn pays its supplier. Such transactions may be recorded at each occurrence of an ad delivery, and may be summarized in a periodic statement, which statement may include detailed information of any number of transactions, or groups of transactions, or invoices.

Also, as are described in further exemplary embodiments, an agency may operate as a pure agency, under which model an agency does not get billed by its supplier(s); instead the pure agency's clients transact directly with the supplier. In this scenario, the pure agency receives remuneration via an agency fee (e.g. broker fee).

In various cases, the agency fee is processed as a separate transaction. Also, in various cases, including both agency as reseller and also agency as pure agency, revenue sharing may be processed as a separate transaction.

Agencies may want to cooperate with other agencies, and may wish to establish interrelationships with other agencies or, more generally, may wish to establish interrelationships with other agencies at large or, still more generally, may wish to establish interrelationships and/or engage in transactions with other entities (i.e. beyond just agencies) and may thus wish to become seat-holders on an exchange.

### Exchange Concepts and Actions

An exchange can be formed comprising any group of entities involved in the trading/matching of advertising placement opportunities, and advertising to fill such placement opportunities. Inasmuch as an agency performs actions on behalf of other entities on the exchange, various instruments are used in the provision of agency services. For example:
Links: Agencies can establish links with entities on the exchange. Links, and their representation in the directed graphs, merely indicate the existence of some relationship, which relationship might involve a monetary transaction, for example an agency (e.g. the ad agency “MadisonAvenue99”) might agree to handle ads for a buyer (e.g. “NikeSports”), and MadisonAvenue99 might agree place ads on an Internet property on behalf of the buyer (e.g. SI.com). In such as case, there is a link between NikeSports (the original buyer in this example) and MadisonAvenue99 (the agency). Also in this example, there is a link between MadisonAvenue99 and SI.com (the original seller).
Agency-Contracts: Agencies can establish an agency-contract (“AC” or agency contract) with a client. One or more agency-contracts might be associated with a given link. For example, NikeSports might enter into an agency-contract with agency MadisonAvenue99 for placement of certain ads on a particular Internet property. Additionally, NikeSports might enter into a second agency-contract with MadisonAvenue99 for placement of certain ads on a different Internet property. In some cases, agency-contracts define agency fees, and/or revenue sharing particulars, and/or broker fees to be paid to agencies.
Agency Users: In cases of a real-world agency (i.e. as distinguished from a virtual agency), an agency is a real-world firm with employees and/or contractors who perform specific roles. Agency users (e.g. duly authorized representatives, employees, contractors, etc) are granted permissions based on roles in order to perform application activities on behalf of their customers. Such activities include placing orders and/or any of the earlier described activities.
Agency Pointer: Orders placed by an agency can be represented as an agency pointer that represents the agency-contract through which the agency was able to place an order.

### Agency Models

Using the above concepts, herein are considered three possible agency models on the exchange:
Agency-Within-Ad-Network: In this model an agency is a managed entity within another Ad-Network. Such an agency signs an agency-contract with the managing Ad-Network under which contract the agency works exclusively with members of the Ad-Network. The agency may or may not act as a pass-through for invoicing and payment; the agency might receive broker fees by the Ad-Network.
Agency-As-Ad-Network: In this model, the agency is a seat-holder on the exchange, and such an agency handles its customers as managed entities within its Ad-Network. Under this model, the agency acts as a pass-through for invoicing and payment, thus there is no need for a separate agency-contract. Referring to the directed graphs discussed of FIG. 1A, FIG. 1B, and FIG. 1C, this is a case where there exists a relationship (e.g. a link) but not a deal (i.e. there is no agency-contract AC associated with the link).
Agency-On-Exchange: In this model, the agency is a seat-holder on the exchange. The agency establishes links and signs agency-contract(s) with other seat-holders on the exchange, thus creating deals between seat-holders. An Agency-On-Exchange can work with the customers of a seat-holder (e.g. specific customers of a seat-holder or all customers of a seat-holder, depending on how the roles are granted). Such an agency may act as a pass-through for invoicing and payment or may act as a reseller for invoicing and payment. Additionally, such an agency might get paid agency fees or broker fees (e.g. for transactions delivered against actions performed by the Agency for an entity in the ad-network).

### Subnets and Exchange: Concepts and Actions

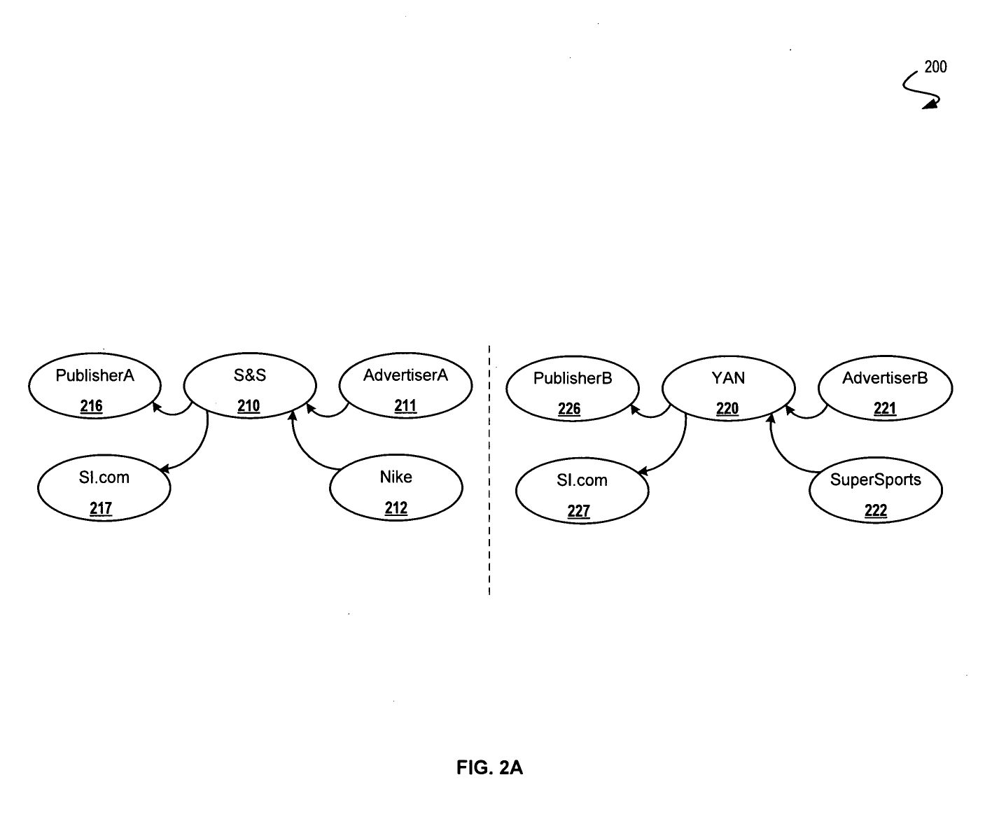

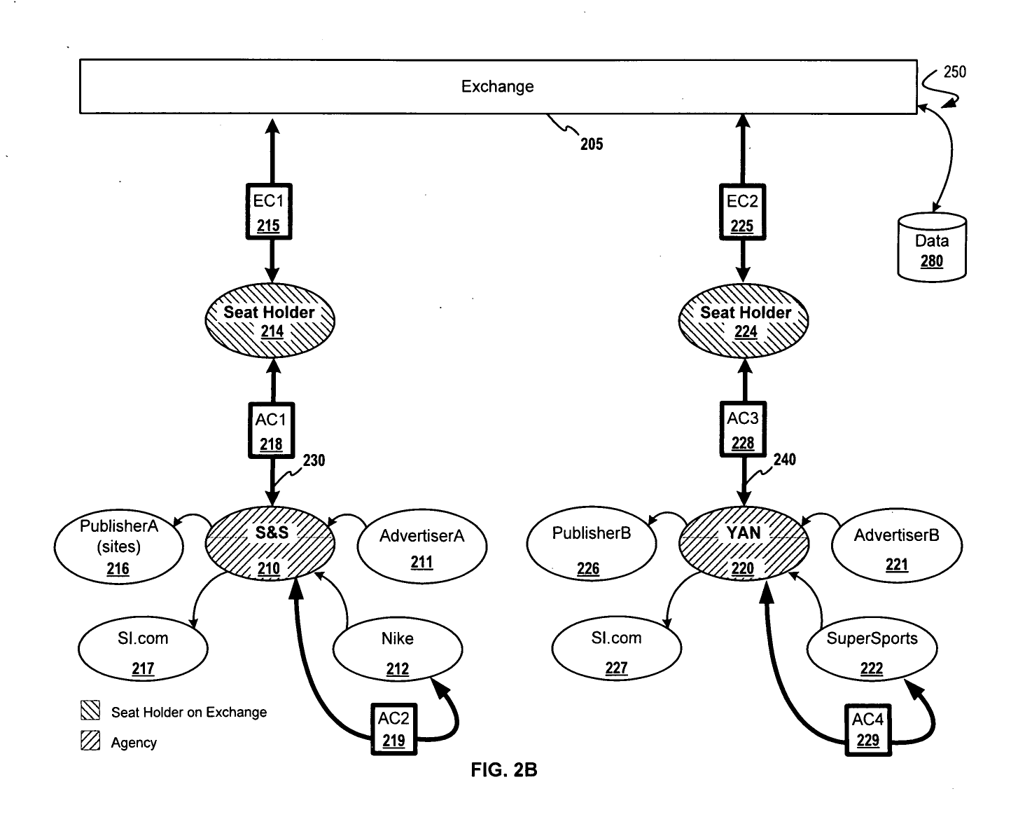

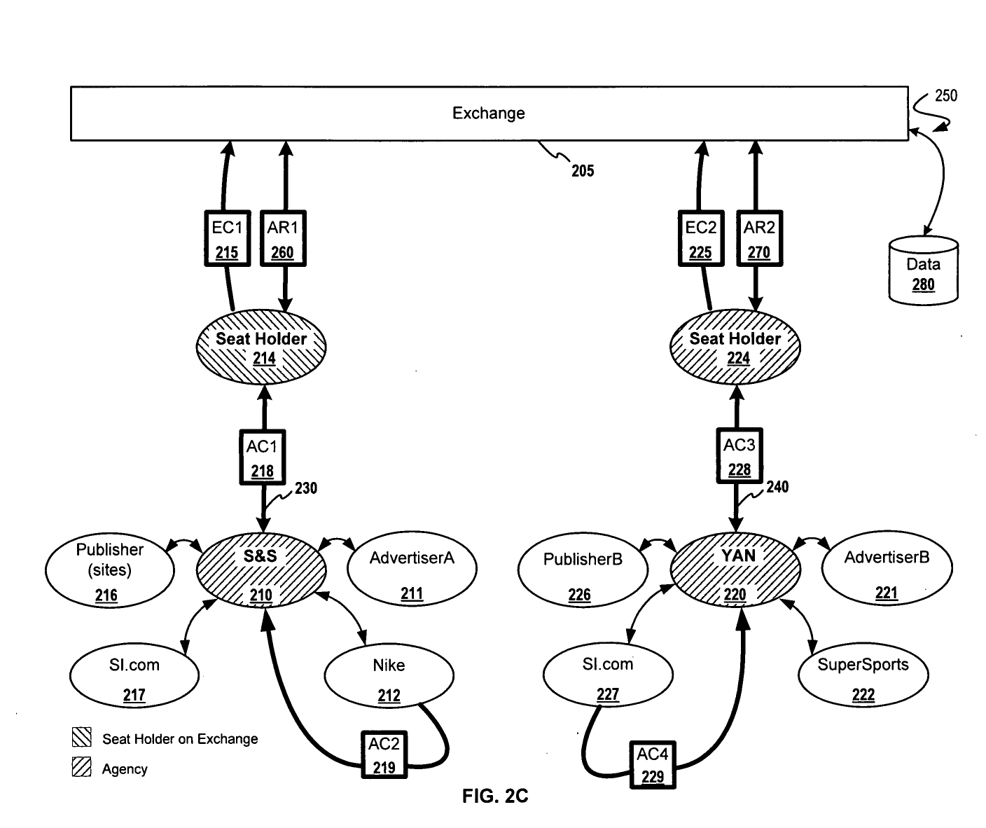

FIG. 2A shows advertising network environments, each showing a path from a buyer to a seller through an intermediary, in which some embodiments operate. Depicted is an exemplary ecosystem in which agencies 210, 220 each operate an ad-network. As shown on the left side, an ad subnet is formed by the agency 210 together with its advertisers (buyers) 211, 212 and its publishers 216, 217. On the right side is a second ad subnet, formed by an agency 220 together with its advertisers (buyers) 221, 222, and its publishers 226, 227. Each agency is able to perform agency functions for the agency's respective customers, and with the agencies' affiliated publishers. However, as shown there are no connections (e.g. graph edges, links, deals, contracts, etc) between the two agencies 210 and 220. This situation exemplifies the agency-within-ad-network model. Thus, in this example, if PublisherA 216 had an ad call suited for a sports-related advertiser, it would be able to receive an advertisement from the advertisers within the subnet (i.e. AdvertiserA 211 or Nike 212), but not from advertisers in another subnet (e.g. not from AdvertiserB 221 or SuperSports 222). Of course an agency is free to establish new agency relationships with any advertiser, and thereby establish a new advertiser in the subnet; however, establishing such a relationship is human-resource and -time intensive. So, clearly in absence of a relationship (for example) between SuperSports 222 and PublisherA 216, such a relationship—possibly facilitated via an ad call from PublisherA 216—cannot be fulfilled by an advertisement from SuperSports 222. What is needed is a system for establishing relationships in a low-cost, flexible, and dynamic manner. Further such a system might support ad serving and revenue sharing beyond the bounds of a particular subnet.

FIG. 2B shows advertising network environments, each showing a path from a buyer to a seller through an intermediary, and including a representation of contracts, in which some embodiments may operate. Depicted is an exemplary ecosystem in which two agencies 210, 220 are each affiliated with an exchange seat-holder, 214 and 224 respectively, and in which ecosystem each agency operates an ad-network. The agencies, namely agency 210 and agency 220 are each affiliated with seat-holders on an exchange 205, as indicated by links 230 and 240, respectively. Becoming a seat-holder on an exchange 205 might involve entering into an exchange contract 215 and 225 (e.g. exchange agreement, exchange membership, EC, etc), respectively. Such an exchange contract might take the form of a legal instrument, signed by a duly appointed representative of each of the entities, and the signature on the legal instrument may be obtained in hand and ink, or may be obtained with a virgule signature. In exemplary cases, the exchange contract subsumes several machine-readable data items (e.g. an electronic form, a data record, a bitmask, etc), and such machine-readable data items can be retrieved by other exchange seat-holders. FIG. 2B also shows an agency-contract AC1 218, as an agency-contract data item shared by the agency 210 and a seat holder 214. Similarly, FIG. 2B also shows an agency-contract AC3 228, as an agency-contract data item shared by the agency 220 and seat-holder 224.

Of course a system implementing any of the above-described agency models might employ a range of data items. Strictly as an example, such data items might include an Order profile (denoted as “O<n>” where n is an integer), a BillTo profile (denoted as “BP<Xn>” where Xn is an account designation), a PayTo profile (denoted as “PP<Xn>” where Xn is an account designation), an AgencyContract profile (denoted as “AC<n>” where n is an integer), a TrafficDeal profile (denoted as “TD<Xn>” where Xn is an account designation), and other data items. Again, strictly as an example, the aforementioned data items might take on the form of a table or relation, and might be represented in any one or more electronically readable forms (e.g. a text record, a binary record, an XML document, an HTML document, etc). Descriptions of an exemplary embodiment, in the form of tables, of each record follow:

TABLE 1
Order Profile

| Field | Value Type | Value Examples |
|---|---|---|
| Order Number | Integer | 1, 2, 3, . . . |
| Agency Pointer | Pointer to the | 0X345678910 |
| | Agency placing the | <AP ptr = “AC1”> |
| | order | |
| Cost | Currency value | $3.25 |

TABLE 2
BillTo Profile

| Field | Value Type | Value Examples |
|---|---|---|
| ID | Integer, String | 1, 2, 3, . . . , “BP-N1” |
| Address | String(s) | 123 Main Street |
| | | Anytown, USA |
| Currency | Currency Symbol | US$, GBP, JPY |
| Contact | String(s) | John Q. Public |
| Default | True/False | True |

TABLE 3
PayTo Profile

| Field | Value Type | Value Examples |
|---|---|---|
| ID | Integer, String | 1, 2, 3, . . . , “PP-A1” |
| Address | | 123 Main Street |
| | | Anytown, USA |
| Currency | Currency Symbol | US$, GBP, JPY |
| Contact | String(s) | John Q. Public |
| Default | True/False | True |

TABLE 4
AgencyContract Profile

| Field | Value Type | Value Examples |
|---|---|---|
| ID | Integer, String | 1, 2, 3, . . . , “AC1” |
| Agency Billing | True/False | True |
| Agency Payment | True/False | False |
| Revenue Share | Percent | 10% |

TABLE 5
TrafficDeal Profile

| Field | Value Type | Value Examples |
|---|---|---|
| ID | Integer, String | 1, 2, 3, . . . , “TD2” |
| Revenue Share | Percent | 50% |
| Buyer Agency Pointer | Integer, String | AP, null |
| Seller Agency Pointer | Integer, String | AP, null |
| Default | True/False | True |

FIG. 2C shows advertising network environments, each showing a path from a buyer to a seller through an intermediary, and including a representation of contracts and access rules, in which some embodiments may operate. Depicted is an exemplary ecosystem in which two entities 210, 220 communicate with seat-holders, 214 and 224, respectively. As shown, seat-holder entity 214 and seat holder entity 220 operate on the exchange, and as such are granted permission to read/write data 280 (possibly through the exchange 205) in order to fulfill roles within the exchange and/or otherwise act on behalf of their respective clients. As shown, the repository of data 280 is accessible through the exchange. Read/Write access to particular data is permitted/restricted based on the characteristics of the deals under which the data corresponds. In this case, seat holder 214 may access data 280 according to access rules 260 derived from agency-contract AC1 218. Similarly, seat holder 224 may access data 280 according to access rules 270 derived from agency-contract AC3 228. In some cases, a network entity may perform multiple roles; for example, a network entity might perform as an agency and also as an ad-network operator, and possibly also as a seat-holder. Shown is an agency contract 219 shown as a path from buyer 212 the respective agency 210. Also shown is an agency contract shown as a path from seller 227 to an agency 220.

Agency-On-Exchange: Ad-Network Revenue Sharing with Pure Agency

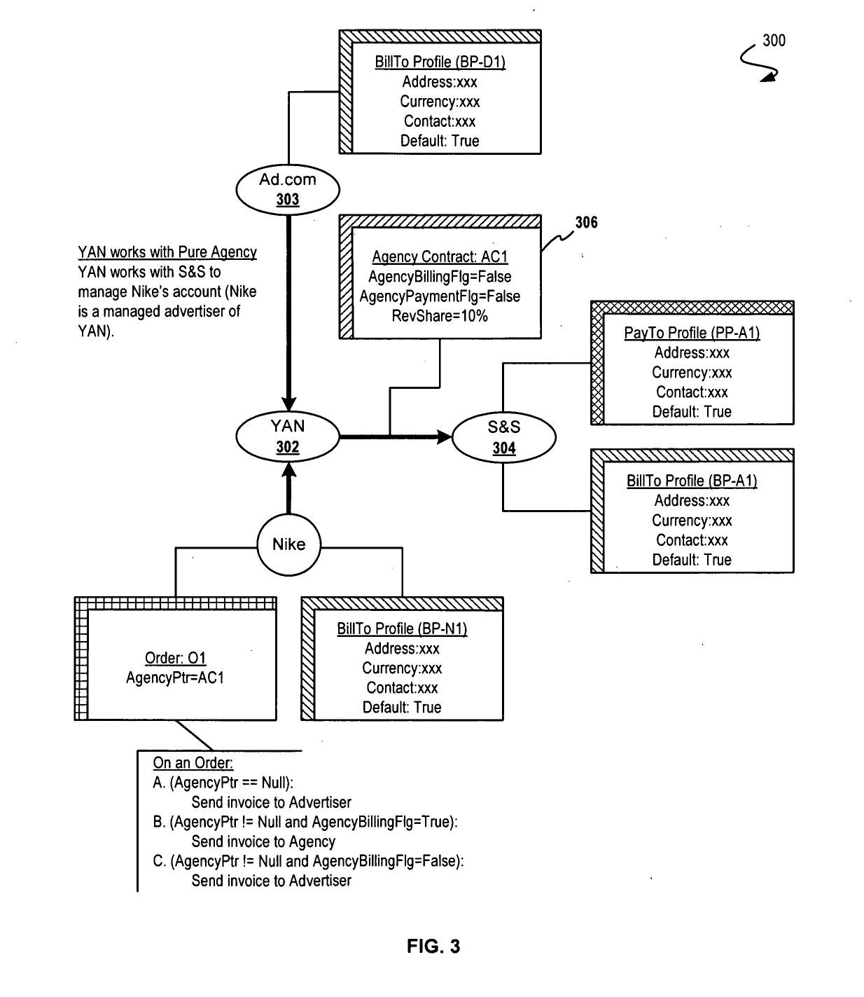

FIG. 3 shows an advertising network environment showing buyers and sellers working with a pure agency intermediary, in which some embodiments operate. Depicted is exchange seat-holder YAN 302 that serves as a broker for S&S 304 (i.e. brokering business between YAN and Nike or between YAN and Ad.com). As shown, S&S is a pure agency for Nike; thus, and following the business model of a pure agency, S&S receives a share of the ad revenue paid by Nike for ads placed on behalf of Ad.com (or more generally on behalf of any advertiser within the YAN advertising network, and covered under an applicable agency-contract). Even as a pure agency, S&S has data record access to place an order for Nike, and does so, yet without becoming a reseller (i.e. maintaining a pure agency relationship between Nike and any ad carriers). In other words, S&S does not get invoiced by YAN (or the publishers) for Nike ad placements. Instead S&S receives payment through revenue sharing. Note that the agency-contract deal 306 between YAN and S&S includes a Revenue Share value, RevShare=“10%”. Within this revenue sharing mechanism, orders for Nike ads (placed by S&S) to be delivered are tagged with an Agency Pointer, AgencyPtr=“AC1” (an agency-contract), which as just mentioned includes a 10% revenue share accommodation. Once that ad has been delivered, a revenue share of 10% is earmarked for S&S.

Further, and as shown in FIG. 3, both YAN and S&S are stakeholders in any Nike transactions under agency-contract AC1, and thus can login to view reports for Nike. Of course in some embodiments, users employed by YAN (an ad-network operator) might be able to see reports across all of YAN's managed advertisers; however, a user employed by S&S might be restricted to view only data for S&S's clients.

When it is time to invoice, an invoice is sent to Nike, and Nike pays YAN. The Revenue Share negotiated under AC1 306 will appear as a separate transaction in the events showing the buyer (or the payor) as YAN, and the seller (or the payee) as S&S. Of course the Revenue Share amount is calculated by applying the RevShare percentage defined on the agency-contract to the transaction amount between Nike and YAN (i.e. the transaction follows the Agency pointer). In some embodiments, the revenue share aggregation (i.e. based on the delivered ads over a time period) are transacted via an automated payment system

### Agency-On-Exchange: Ad-Network Invoices Reseller

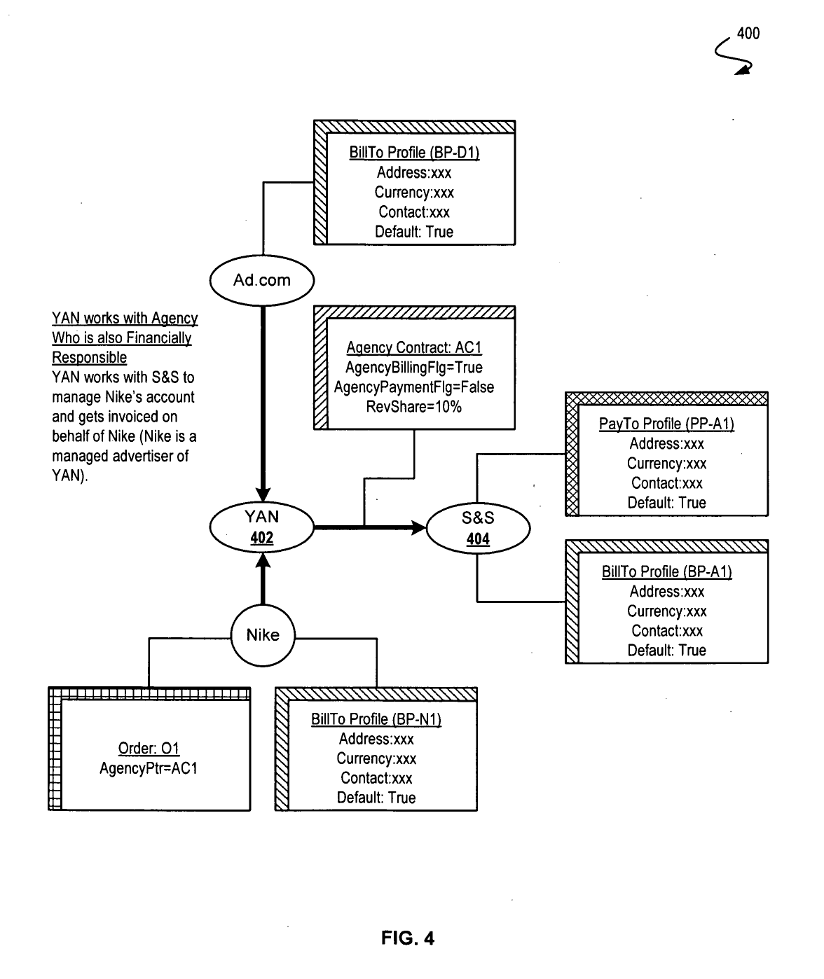

FIG. 4 shows an advertising network environment showing buyers and sellers working with an agency who is a reseller, in which some embodiments operate. Depicted is an exemplary ecosystem in which exchange seat-holder YAN 402 is doing business with broker S&S 404. As shown, S&S is doing business with YAN, and is also acting as a reseller on behalf of Nike; thus, and following the business model of a reseller, S&S receives an invoice from the YAN advertising network for ads placed against S&S orders.

Of course as a reseller, S&S has access to place an order for Nike. Also, as a reseller S&S has financial responsibility for the order; thus, and according to the business model for a reseller, gets invoiced by YAN for delivery of ads ordered by S&S (e.g. on behalf of Nike), and in turn S&S, of its own accord, invoices Nike separately. Characteristics of the BillTo profile permit performance of credit limit checks on S&S. In this mode, when ad serving traffic comes in, the resulting impressions are marked with Nike as the advertiser, and S&S as the agency. Within a reseller arrangement, both YAN and S&S can login to view reports for Nike. Users from YAN might be able to see reports across all managed advertisers, but a user from S&S might be restricted to view reports and data for Nike only. The billing system follows the Agency Pointer on the Order and uses the BillTo information on the Agency Contract to Bill S&S. Agency RevShare will appear as a separate transaction in the events. This transaction will have the buyer (or the payor) as YAN, and the seller (or the payee) as S&S. The RevShare amount is calculated by applying the RevShare defined in the agency-contract to the transaction amount between Nike and YAN. YAN pays the agency its RevShare based on these transactions, possibly through an automated payment system, according to one embodiment.

Agency-On-Exchange: Demand Provider Coordinates with Reseller

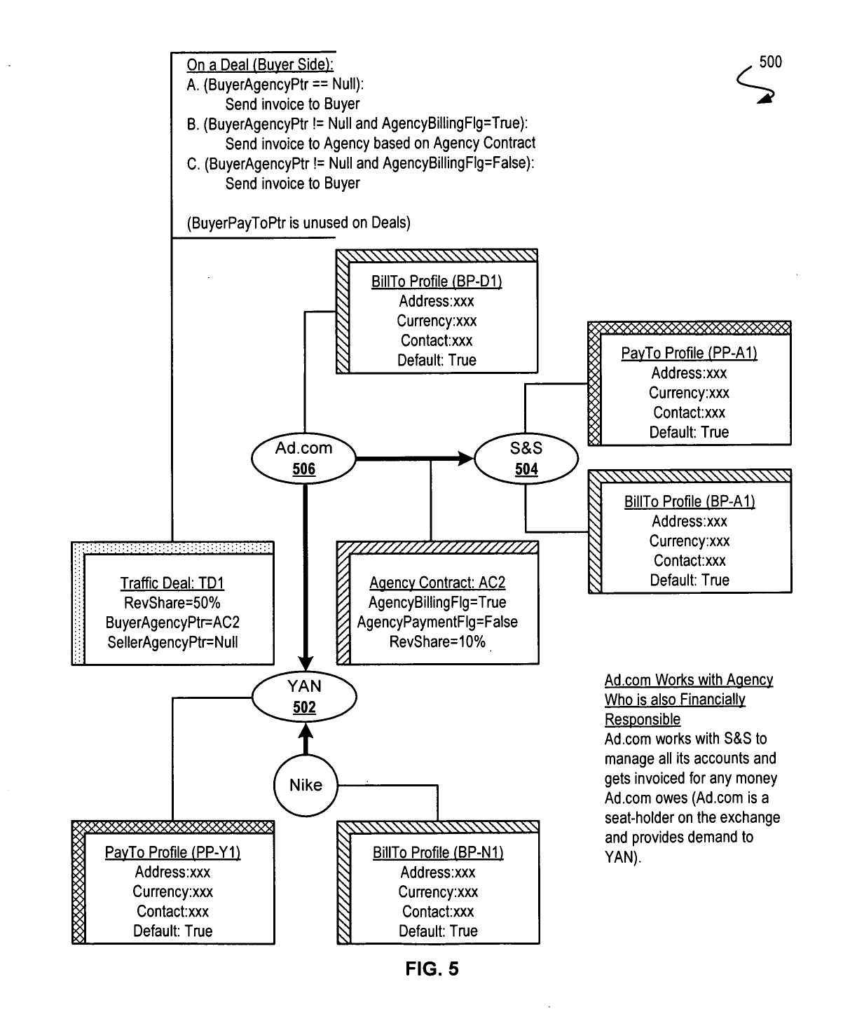

FIG. 5 shows an advertising network environment showing buyers and sellers working with an Agency intermediary, in which some embodiments operate. Depicted is an exemplary ecosystem in which an exchange seat-holder Ad.com 506 conducts business with reseller S&S 504. The seat-holder 506 can be considered to be an aggregator. In this example, S&S has access in order to propose and approve deals on behalf of Ad.com (e.g. from Ad.com 506 to YAN 502). S&S also wants to get invoiced for any traffic that flows along this deal from Ad.com to YAN. Characteristics of the BillTo profile permit performance of credit limit checks on S&S. In other words, this example is a cross-sell scenario (with Ad.com selling on the YAN advertising network). Characteristics of the BillTo profile permit performance of billing activities by following the agency pointer and sending invoices to S&S. When traffic comes in, impressions are marked with Ad.com as the buyer, and YAN as the seller. Revenue share aggregations are performed for both Ad.com and YAN. Both Ad.com and S&S can login to view reports pertaining to Ad.com. The exchange system will calculate and determine how much an agency needs to be paid/invoiced depending on the situation. In this example, S&S is a ‘Buyer Side’ agency for the Ad.com-to-YAN deal. Agency RevShare will appear as a separate transaction in the events. This transaction will have the buyer (or the payor) as Ad.com, and the seller (or the payee) as S&S. The RevShare amount is calculated by applying the RevShare defined on the agency-contract to the transaction amount between Ad.com and YAN (serving follows the Agency pointer). Agency RevShare appears in the cost feed reports of Ad.com, and Ad.com in turn pays S&S. Agency RevShare also appears in the cost feed reports of S&S.

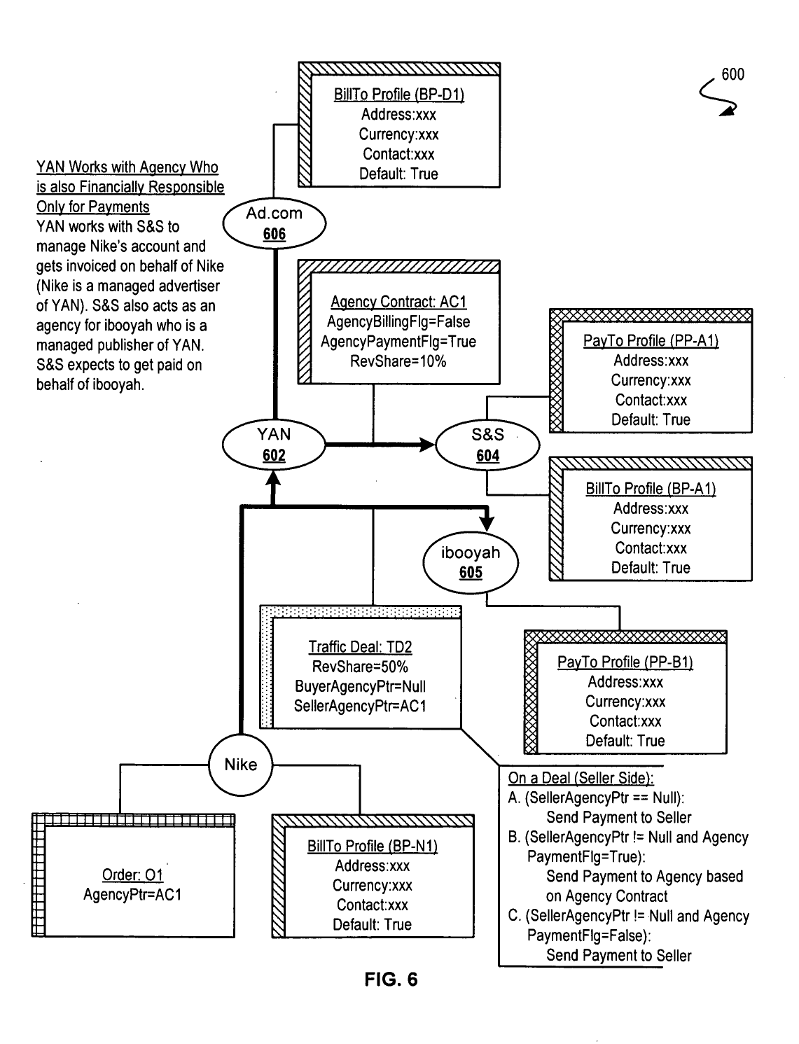

FIG. 6 shows an advertising network environment showing buyers and sellers working with an agency, in which some embodiments operate. Depicted is an exemplary ecosystem in which an exchange seat-holder YAN 602 does business with S&S 604. In this example S&S has access to propose and approve deals with YAN-managed publishers, on behalf of YAN (e.g. from YAN to ibooyah). S&S gets paid on behalf of ibooyah; S&S then pays ibooyah separately. When traffic comes in, impressions are marked with YAN as the buyer and ibooyah as the seller. Revenue share aggregations are performed for YAN. Both YAN users and S&S users can login to view reports. In this example, S&S can only view data for ibooyah, but not any other managed accounts of YAN. Payable balances are accumulated for ibooyah on a per-deal basis. When it is time to pay, a payment system sends the payment to S&S (the payee can be known by following the agency pointer on the deal from YAN to ibooyah). Agency RevShare will appear as a separate transaction in the events. This transaction will have the buyer (or the payor) as YAN, and the seller (or the payee) as S&S. The RevShare amount is calculated by applying the RevShare defined on the agency-contract to the transaction amount between YAN and ibooyah. YAN pays the Agency its RevShare, based on these transactions, through a payment system. Agency RevShare also appears in the cost feed reports of S&S.

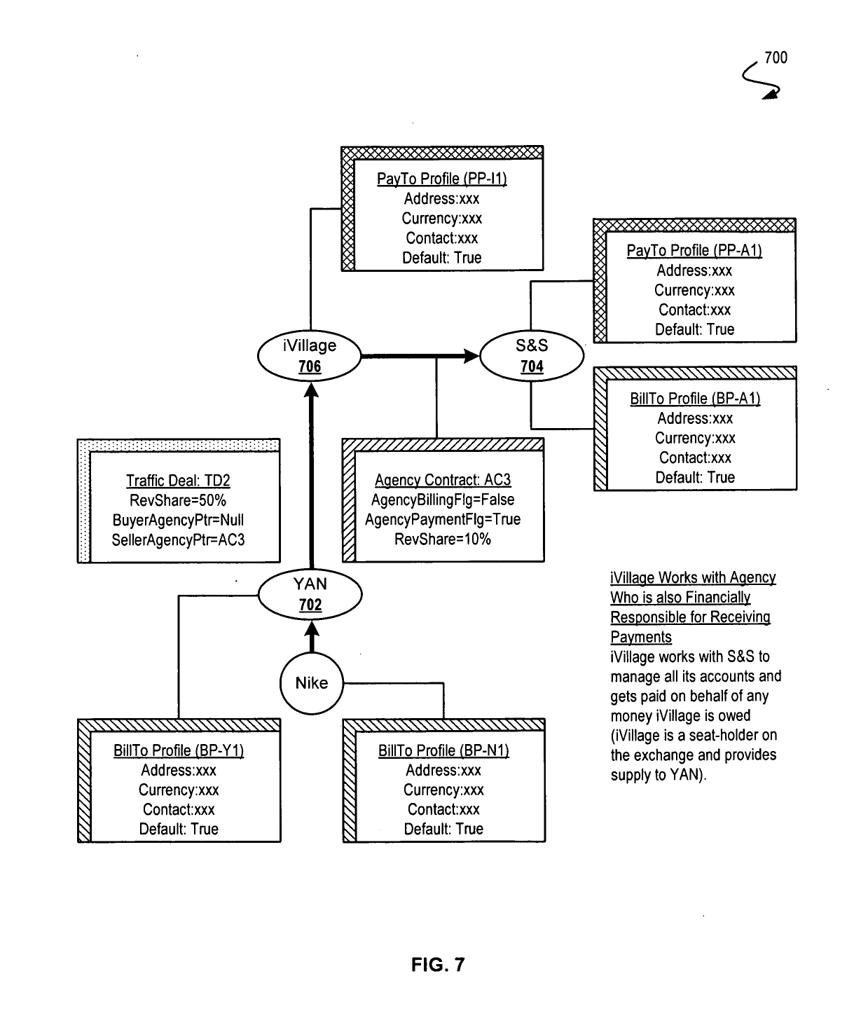

FIG. 7 shows an advertising network environment showing buyers and sellers working with an agency as an aggregator, in which some embodiments may operate. Depicted is an exemplary ecosystem in which a supply provider on the exchange works with a reseller. In this example, entity iVillage 706 is a seat-holder on the exchange, and provides supply to YAN 702. The entity iVillage works with S&S 704 to manage all its accounts. S&S gets paid on behalf of iVillage. S&S has access in order to propose and approve deals on behalf of iVillage (e.g. from YAN to iVillage). S&S gets paid on behalf of iVillage. In turn, S&S pays the share owed to iVillage separately. When traffic comes in, impressions are marked with YAN as the buyer and iVillage as the seller. Revenue share aggregations are performed for YAN and iVillage. Both iVillage users and S&S users can login to view reports. Payable balances are accumulated for iVillage on a per-deal basis In some embodiments, when it is time to pay, an automated payment system sends the payment to S&S (e.g. by following the Agency Pointer on the deal from YAN to iVillage, and based on how the PayTo profile is defined). In this example, S&S is a ‘Seller Side’ agency for the YAN-to-iVillage deal. Agency RevShare will appear as a separate transaction in the events. This transaction will have the buyer (or the payor) as iVillage, and the seller (or the payee) as S&S. The RevShare amount is calculated by applying the RevShare defined on the agency-contract to the transaction amount between YAN and iVillage. Agency RevShare portions appear in the cost feed reports of iVillage and iVillage pays S&S. Agency RevShare also appears in the cost feed reports of S&S.

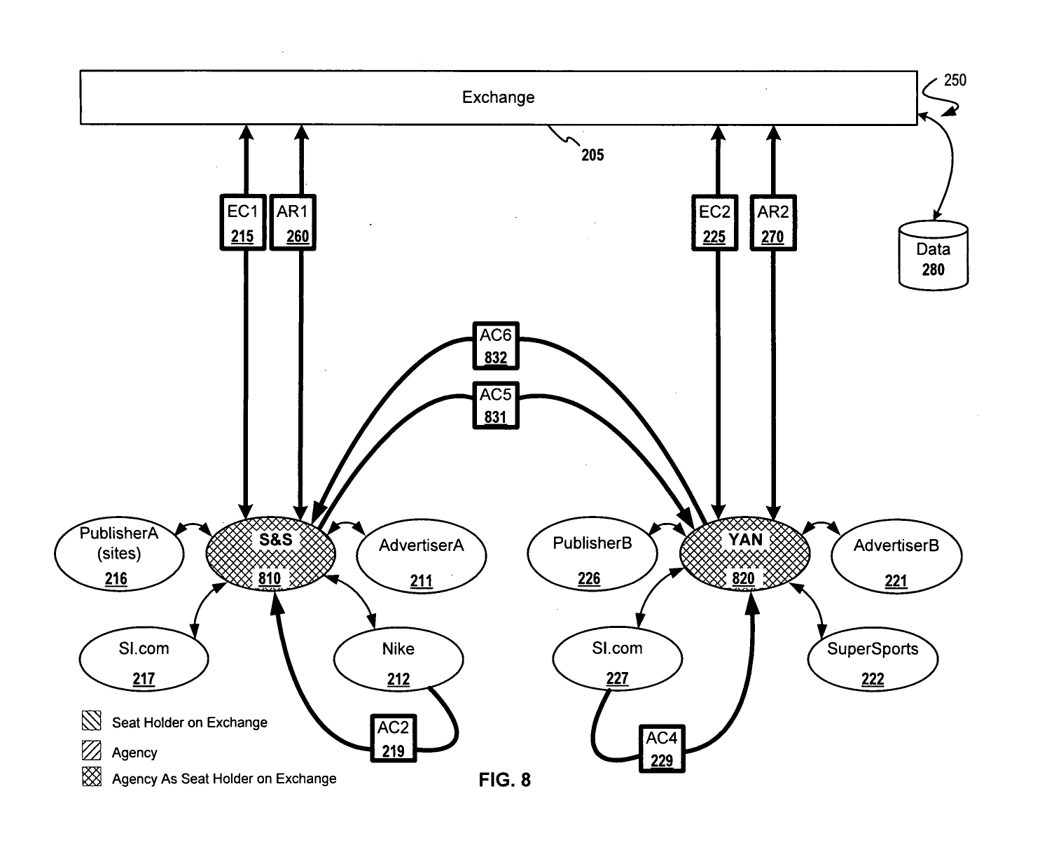

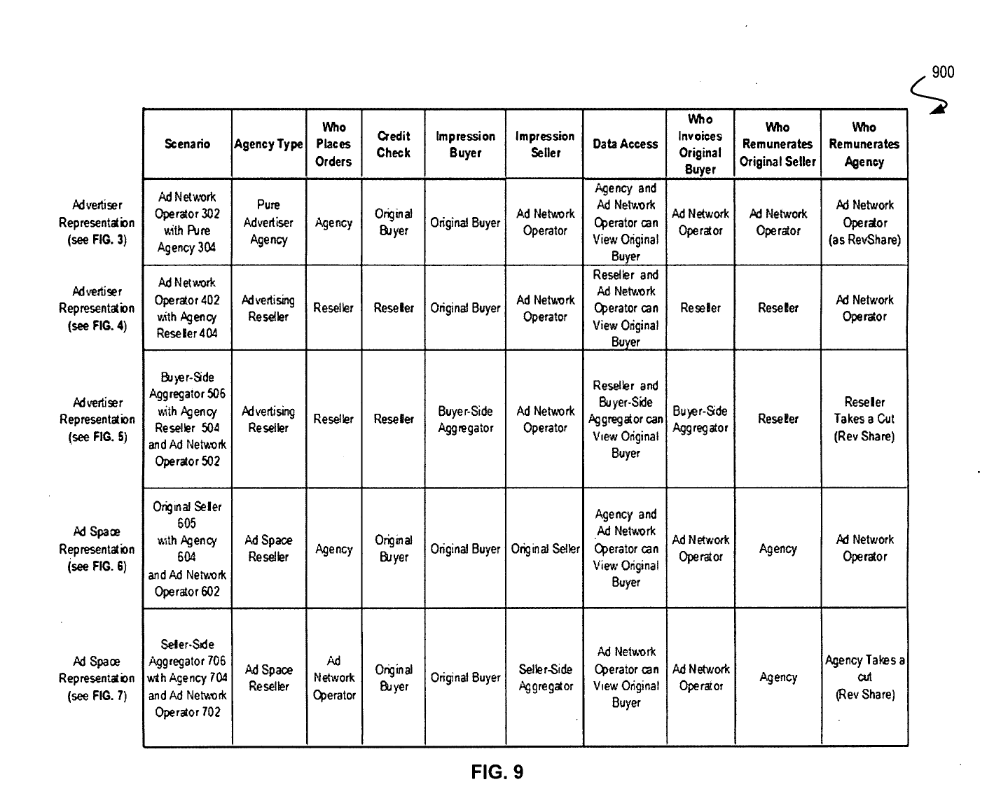

FIG. 8 shows an advertising network environment showing paths from buyers to sellers, including intermediaries, in which some embodiments may operate. As mentioned in the discussion of FIG. 2C, the two entities 210, 220 communicate with a seat-holders, 214 and 224, respectively. Again, referring back to the embodiment of FIG. 2C, the entity 210 is an agency, placing ads on behalf of clients 211 and 212. Also, agency 210 is a managed entity within the ad-network formed by seat holder 214. Such an agency 210 signs an agency-contract 218 with the managing exchange seat holder 214 under which contract the agency works exclusively with members of the seat holder's ad-network. The agency may or may not act as a pass-through for invoicing and payment; the agency might receive broker fees by the seat holder.

As earlier described, a network entity may perform multiple roles; for example, a network entity might perform as an agency and also as an ad-network operator, and possibly also as a seat-holder. Such is the case as shown in FIG. 8. This situation is earlier described as agency-as-ad-network. In this model, and as shown in FIG. 8, the agency 810 is also a ad-network operator 810 on the exchange, and such an agency handles its customers as managed entities within its ad-network. Under this model, the agency acts as a pass-through for invoicing and payment, thus there is no need for a separate agency-contract. That is, since the agency is itself performing the role of ad-network operator, the agency-contract between the agency and ad-network operator is implicit. The agency 810 might perform as an agency and also as an ad-network operator, however, absent any access to the exchange (e.g. through contract EC1 215 and/or access rules AR1 260), the agency 810 serves only within its own ad-network.

Continuing with this discussion, FIG. 8 also depicts a model of agency-on-exchange. In this model, the agency 810 is also a seat-holder 810 on the exchange. The agency establishes links and signs agency-contract with other seat-holders (e.g. seat holder 820). As shown the agency 810 can work with any one or more customers of a seat-holder 820, or even all customers of seat-holder 820, depending on the terms of the agency contract 831. In this model, an agency 810 may or may not act as a pass-through for invoicing and payment, depending on the terms of the agency contract 831. Similarly, the agency 810 might get paid broker fees for transactions delivered against actions performed by the agency 810 on behalf of seat-holder 820. Of course this model can be asymmetric or symmetric. That is, the agency contract 831 might only contain provisions for YAN 820 to perform on behalf of the clients of S&S 810. Conversely, the agency contract 832 might only contain provisions for S&S 810 to perform on behalf of the clients of YAN 820. In a symmetric case, the provisions of agency contract 831 and agency contract 832 and the provisions of agency contract 832 might be both concurrently in force.

In more formal terms, one embodiment depicted in FIG. 8 is a method for transacting with an agency 810 participating on an advertising exchange network (i.e. in the role of a seat-holder 820) having a plurality network entities (e.g. PublisherA 216, SI.com 217, AdvertiserA 211, Nike 212, S&S 810, YAN 820). In embodiments, the method includes storing a network representation of the plurality network entities (e.g. PublisherA 216, SI.com 217, AdvertiserA 211, Nike 212, S&S 810, YAN 820), wherein the network representation of the plurality of network entities includes an identification of at least one agency (e.g. 810) and an identification of at least one network entity (e.g. any of PublisherA 216, SI.com 217, AdvertiserA 211, Nike 212). In some cases of such a network representation, identification of an agency that participates as a seat-holder on said advertising exchange (e.g. 810 or 820) and also the network representation includes identification of at least one network entity (e.g. any of Publisher 216, SI.com 217, AdvertiserA 211, Nike 212) that does not participate as a seat-holder on the advertising exchange 205. Some embodiments of the method also include steps for transmitting to the advertising exchange network 205, an opportunity to serve an online advertisement; steps for selecting, one or more network entities (e.g. PublisherA 216, PublisherB 226, SI.com 217, SI.com 227) to deliver the online advertisement. Computer-aided or server-based embodiments include steps for traversing the network representation wherein the traversal includes creating at least one agency transaction corresponding to the opportunity to serve an online advertisement. For billing and other purposes, embodiments of the method include steps for storing said at least one agency transaction indicating participation of the agency in the transaction.

FIG. 9 is a chart showing agency attributes over a series of agency scenarios, according to one embodiment. As shown in this chart 900, various agency representation scenarios are compared/contrasted with other agency representation scenarios. An agency might represent an advertiser, or might represent an ad space provider, or might represent an aggregator of either advertisers or ad space providers.

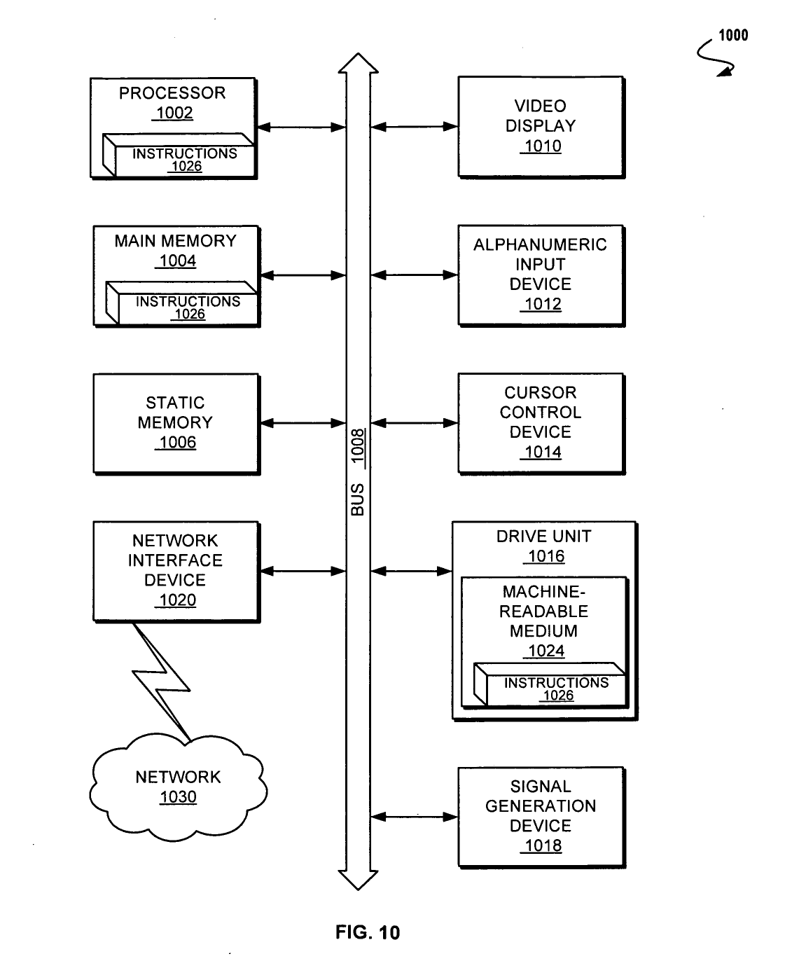

FIG. 10 is a diagrammatic representation of a machine in the exemplary form of a computer system 1000, within which a set of instructions for causing the machine to perform any one of the methodologies discussed herein may be executed. The embodiment shown is purely exemplary, and might be implemented in the context of one or more of FIG. 1A through FIG. 9. In alternative embodiments, the machine may comprise a network router, a network switch, a network bridge, a Personal Digital Assistant (PDA), a cellular telephone, a web appliance, or any machine capable of executing a sequence of instructions that specify actions to be taken by that machine.

The computer system 1000 includes a processor 1002, a main memory 1004 and a static memory 1006, which communicate with each other via a bus 1008. The computer system 1000 may further include a video display unit 1010 (e.g. a liquid crystal display (LCD) or a cathode ray tube (CRT)). The computer system 1000 also includes an alphanumeric input device 1012 (e.g. a keyboard), a cursor control device 1014 (e.g. a mouse), a disk drive unit 1016, a signal generation device 1018 (e.g. a speaker), and a network interface device 1020.

The disk drive unit 1016 includes a machine-readable medium 1024 on which is stored a set of instructions (i.e. software) 1026 embodying any one, or all, of the methodologies described above. The software 1026 is also shown to reside, completely or at least partially, within the main memory 1004 and/or within the processor 1002. The software 1026 may further be transmitted or received via the network interface device 1020 over the network 1030.

It is to be understood that embodiments of this invention may be used as, or to support, software programs executed upon some form of processing core (such as the CPU of a computer) or otherwise implemented or realized upon or within a machine or computer readable medium. A machine readable medium includes any mechanism for storing or transmitting information in a form readable by a machine (e.g. a computer). For example, a machine readable medium includes read-only memory (ROM); random access memory (RAM); magnetic disk storage media; optical storage media; flash memory devices; electrical, optical, acoustical or other form of propagated signals (e.g. carrier waves, infrared signals, digital signals, etc.); or any other type of media suitable for storing or transmitting information.

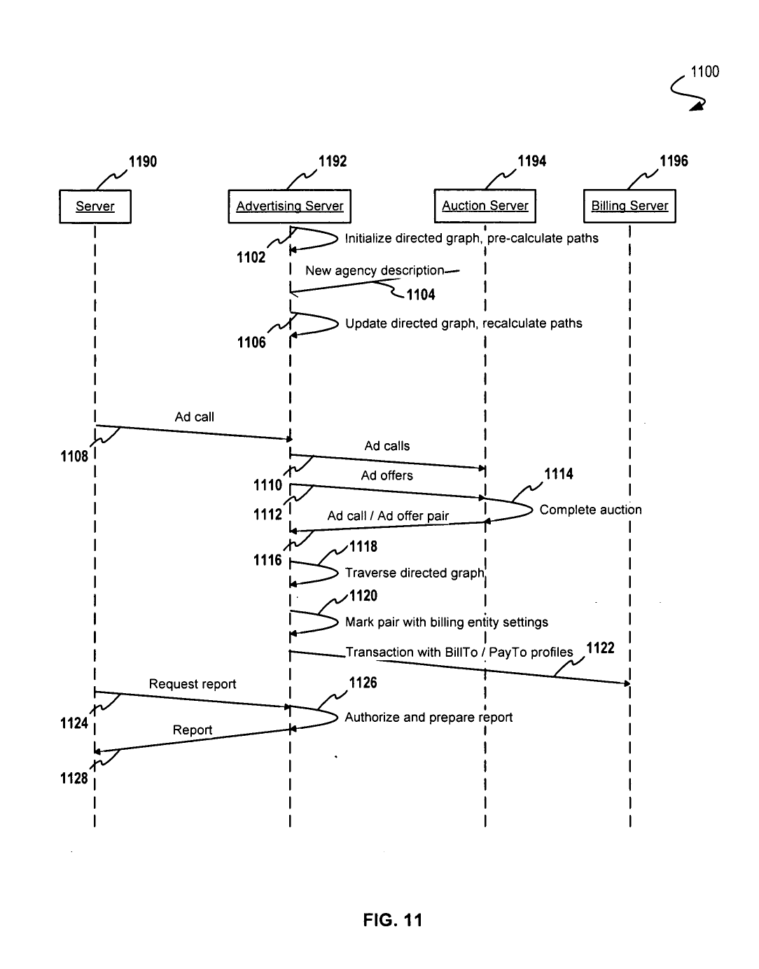

FIG. 11 is a diagrammatic representation of several computer systems (i.e. server 1190, advertising server 1192, auction server 1194, and billing server 1196) in the exemplary form of a multi-server network 1100, within which environment a communications protocol may be executed. The embodiment shown is purely exemplary, and might be implemented in the context of one or more of FIG. 1A through FIG.10. The server network 1100 implements a communications protocol for transacting with an advertising agency participating on an advertising exchange. As shown, the servers 1190, 1192, 1194, and 1196 cooperate via message exchange and intra-server operations to implement a communications protocol for transacting with an advertising agency that is participating on an advertising exchange. The system 1100 is strictly exemplary and the names of any particular server, and the assignment of any particular operations to any specific servers and also any specific initiator and recipient of any messages is also strictly exemplary. As shown, operation 1102 serves to initialize a directed graph having at least one original buyer and one original seller, and one intermediary. In a graphical representation of such a directed graph, the directed edges of the graph indicate the flow of payments. Of course a practical embodiment would contain any number, possibly even a large number of nodes and edges in the directed graph, thus embodiments might pre-calculate any paths from any original buyer to any original seller, passing through any number of intermediary nodes (e.g. pure agencies, agencies as resellers, aggregators, agencies for aggregators, etc). In fact a pre-calculation might determine the best path to take from a given original buyer to an original seller. In this context, the adjective ‘best’ might refer to the best path to maximize return for a publisher, or ‘best’ might refer to the best path to reduce cost, or ‘best’ might refer to a path with the minimum number of hops, etc or any other objective function for that matter. Now, as shown by the asynchronous event 1104, namely receiving a new agency description, the addition of a new agency might cause the directed graph to be updated, and the paths recalculated. The operations 1102 and 1106 might be performed before any advertisements are served.

At serving time, an ad placement within the context of a system and method for transacting with an advertising agency participating on an advertising exchange, might be initiated by an ad call 1108. An ad call might be matched to any number of ad offers, and one or more ad offers sent to auction (see transaction 1112). As the conclusion of the auction (see operation 1114) the ad call might then be matched to an ad offer, creating at least one ad call/ad offer pair (see operation 1116). Such an ad call and ad offer pair then fairly represents the start point (original buyer) and ending point (original seller) of a path on the directed graph, and objective function can be used to identify an optimal path (see operation 1118). Having such a path enumerated then, traversal of the path yields billing settings and revenue sharing settings for that ad placement (see operation 1120). In some cases, the billing settings and/or revenue sharing calculations of the transaction are sent to a billing server (see transaction 1122). Of course the existence of a billing server is strictly exemplary, and billing functions could be performed on any server. A report might be requested at any time (see operation 1124) and a server might prepare the requested report, possibly observing any access rules (see operation 1126). The prepared report might then be transmitted to the requested (see operation 1128).

In slightly more formal terms, an embodiment of a method to distribute online advertising revenue to online exchange advertising network entities, might be described as: creating a directed graph representation of a plurality network entities on a first server (operation 1102, operation 1106); receiving an ad call and ad offer pair from a second server (see transaction 1112); marking the pair with at least one agency identification (see operation 1120); and sending a transaction report to a third server (see transaction 1122). As may now be fully appreciated, initializing the directed graph (i.e. storing a network representation of the plurality network entities) in an ecosystem involving an agency-on-exchange may include an identification of at least one agency that participates on a particular advertising exchange and identification of at least one other network entity that does not participate on the particular advertising exchange.

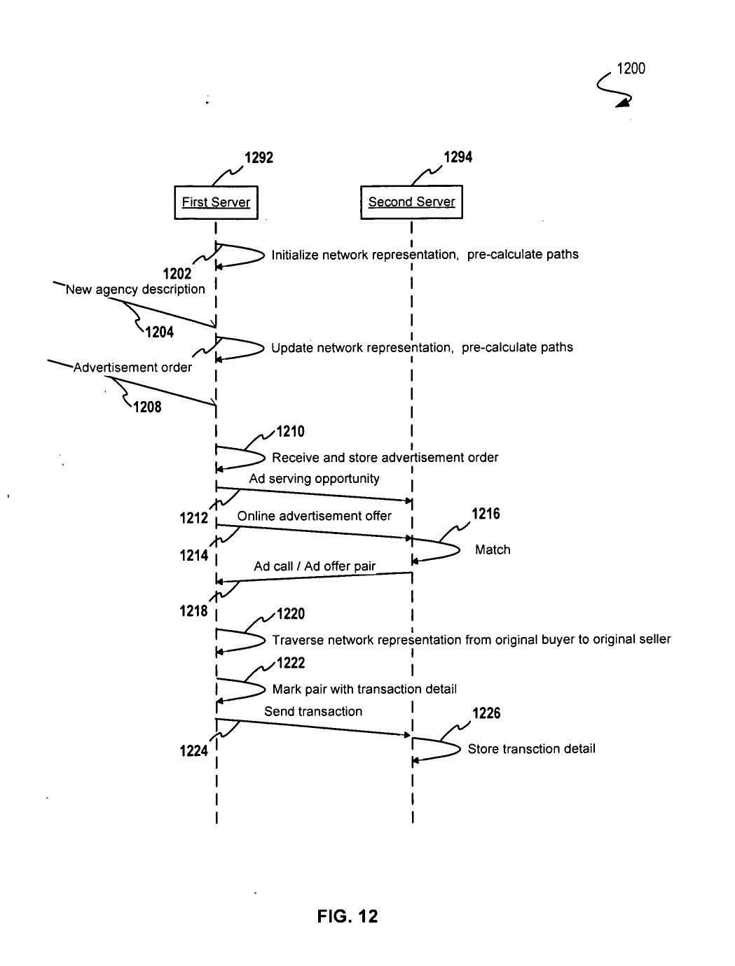

FIG. 12 is a diagrammatic representation of two computer systems (i.e. a first server 1292 and a second server 1294) in the exemplary form of a two-server network 1200, within which environment a communications protocol may be executed. The embodiment shown is purely exemplary, and might be implemented in the context of one or more of FIG. 1A through FIG. 11. The embodiment of 1200 shows two servers, although this architecture is strictly exemplary, and the method for transacting with an advertising agency participating on an advertising exchange network might be implemented on fewer (or more) servers. As shown, the two-server network 1200 implements a method for transacting advertising business with an advertising agency. In most situations, an agency is an intermediary in ad delivery transactions, and derives revenue by participating in transactions performed on an advertising exchange network having a plurality of network entities (e.g. buyers, sellers, buyer representatives, seller representatives, resellers, other intermediaries, etc).

In order to automate an advertising agency's participation in ad delivery transactions between the actual original buyer and the original seller, operation 1202 provides for creating a directed graph network representation of the plurality network entities. In this case, the network representation involves an agency-on-exchange ecosystem that includes (1) an identification of at least one agency that participates on a particular advertising exchange, and (2) identification of at least one other network entity that does not participate on the particular advertising exchange. Of course such a network (e.g. a network of buyers, sellers, and intermediaries, etc) might change frequently, and thus the network representation might also change frequently. As shown, a new agency (or other network entity for that matter) might enter the network asynchronously (see event 1204), and such an event might cause the network representation to be reconstructed. Inasmuch as transacting with an advertising agency participating on an advertising exchange network might include matching advertisements (e.g. ad offers) into advertising spots (e.g. ad calls), it is reasonable that a buyer's request for ad placements (e.g. an ad order) be defined (see message 1208) and made available (e.g. as an ad offer to buy) to potential sellers (see operation 1210). Upon occurrence of an ad serving opportunity (e.g. ad call), message 1212 provides for transmitting an opportunity to serve an online advertisement. Generally the data structure or message embodying the opportunity includes the identification of the original seller. Now, with an ad call and an ad offer both existing concurrently but yet unmatched, operation 1216 provides for matching an opportunity to an online advertisement to form a call/offer pair, which call/offer pair data structure includes the identification the original buyer.

Now, in order to identify and compensate or otherwise include the agency (or agencies) in the ad delivery transaction, operation 1220 serves for traversing the network representation through at least one path from the original buyer to the original seller, and identifying the agency (or agencies) involved in the transaction as intermediaries (see operation 1222). Of course many such transactions might occur within any given arbitrarily small time period, however payments or invoicing or both might occur at a much slower rate, so message 1224 and operation 1226 serve for storing the transaction detail in a format capable of indicating any number of aspects (e.g. invoicing, billing, revenue sharing, etc) of participation by the agency.

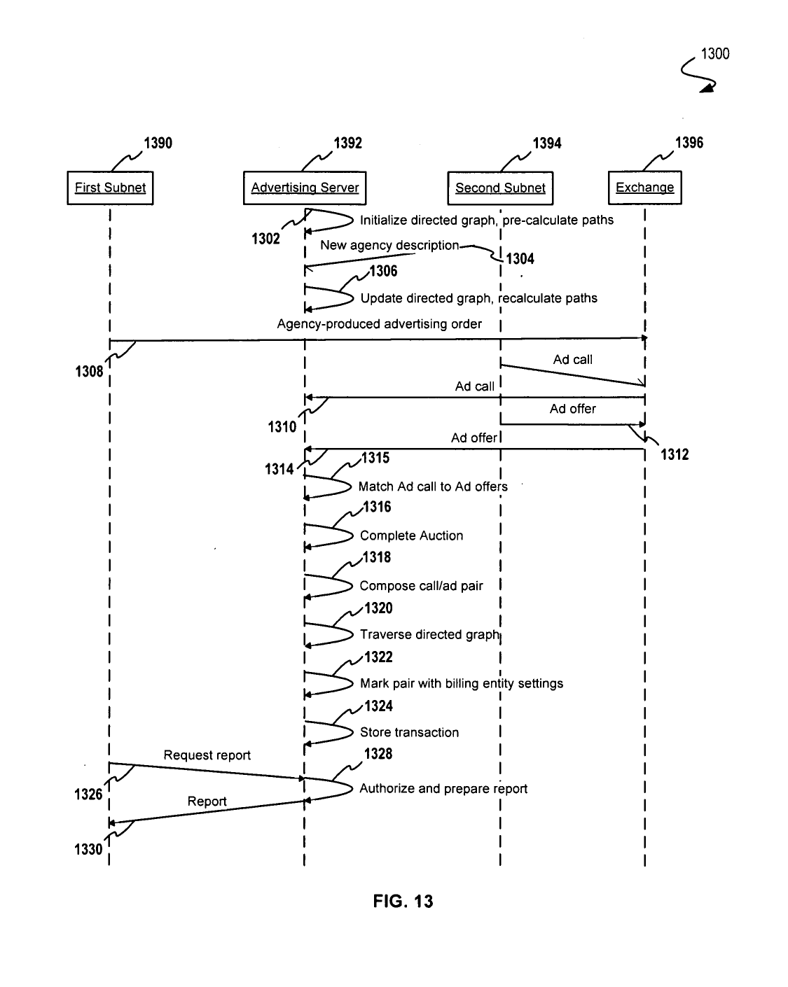

FIG. 13 is a diagrammatic representation of several computer systems (i.e. a first subnet server 1390, an advertising server 1392, a second subnet server 1394, and an exchange server 1396) in the exemplary form of a server network 1300 within which environment a communications protocol may be executed. The embodiment shown is purely exemplary, and might be implemented in the context of one or more of FIG. 1A through FIG. 12. The server network 1300 implements a communications protocol for transacting with an advertising agency participating on an advertising exchange. As shown, the servers 1390, 1392, 1394, and 1396 cooperate via message exchange and intra-server operations to implement a communications protocol. The system 1300 is strictly exemplary and the assignment of operations to specific servers, and also the specific initiator and recipient of the messages, is also strictly exemplary. As shown, the method for transacting with an advertising agency participating as an exchange seat-holder on an advertising exchange network might include operations for creating on a server a network representation of a plurality of network entities, each connected (directly or indirectly) to at least one exchange server 1396. In exemplary embodiments, a node representing a seller on the network representation includes an identification of at least one original seller (even if the node itself represents an intermediary). Also, as is inherent in the communications protocol as shown, an original seller is participating on a first subnet (e.g. including server 1390), and that original seller is represented on the exchange by virtue of the agency-produced advertising order (see message 1308). As earlier indicated, since the agency is a seat-holder on the exchange, the order is received by the exchange. Of course other techniques might be used for propagating an agency-produced advertising order to the exchange.

Now, it can be understood that since there exists a connection between an entity on a first subnet 1390 and an entity on a second subnet 1394, it is reasonable that an ad call originating from a first subnet might be matched to an ad offer from a second subnet. Such is the situation exemplified by messages 1308 and 1312. That is, the exchange sets up (through messages 1310 and 1314) the possibility to match an ad call from a first subnet to an ad offer from a second subnet. It should be noted that such a possibility would not exist were it not for some intermediary; in this case, the intermediary is any number of network entities, at least one of which is an agency participating as a seat-holder on the exchange 1396. Continuing, the operation 1315 serves for matching an ad call (i.e. an opportunity to serve an online advertisement) to ad offers, which might be further subjected to an auction (operation 1316), which auction may result in an ad call/ad offer pair. The processing continues in this exemplary embodiment by traversing the network representation through paths from the original buyer to the original seller. In this example, such a traversal includes traversing through network entities (some of which do not participate as a seat-holder on the advertising exchange) including the agency that produced the aforementioned agency-produced advertising order (which agency does participate as a seat-holder on the advertising exchange).The transaction corresponding to the opportunity to serve an online advertisement (message 1310) is then stored (see operation 1324). The agency on the first subnet might then request a report (message 1326) and review any returned report (message 1330), which report might show details of the ad delivery transactions corresponding to the agency-produced advertising order (message 1308).

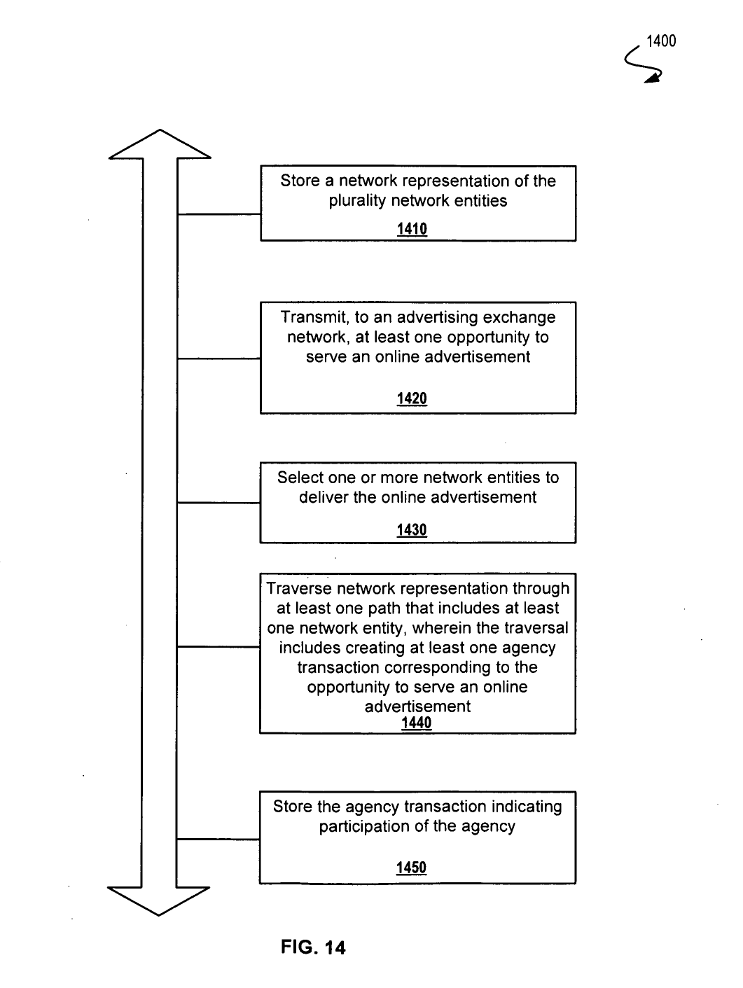

FIG. 14 is a flow chart showing operations for a method for transacting with an advertising agency participating on an advertising exchange. The steps might be executed in serial fashion, or they might be executed in parallel or partially serially, and partially in parallel. The embodiment shown is purely exemplary, and might be implemented in the context of one or more of FIG. 1A through FIG.13. The embodiment of 1400 shows five operations, although this architecture is strictly exemplary, and the method for transacting with an advertising agency participating on an advertising exchange network might be implemented using fewer (or more) operations. As shown, FIG. 14. depicts a method for transacting with an advertising agency participating on an advertising exchange network having a plurality network entities, comprising operations for storing a network representation of the plurality network entities (see operation 1410), transmitting at least one opportunity to serve an online advertisement (see operation 1420), selecting one or more network entities to deliver said online advertisement (see operation 1430), traversing the network representation through at least one path that includes at least one network entity (see operation 1440), and storing the agency transaction indicating participation of the agency in the transaction (see operation 1450).

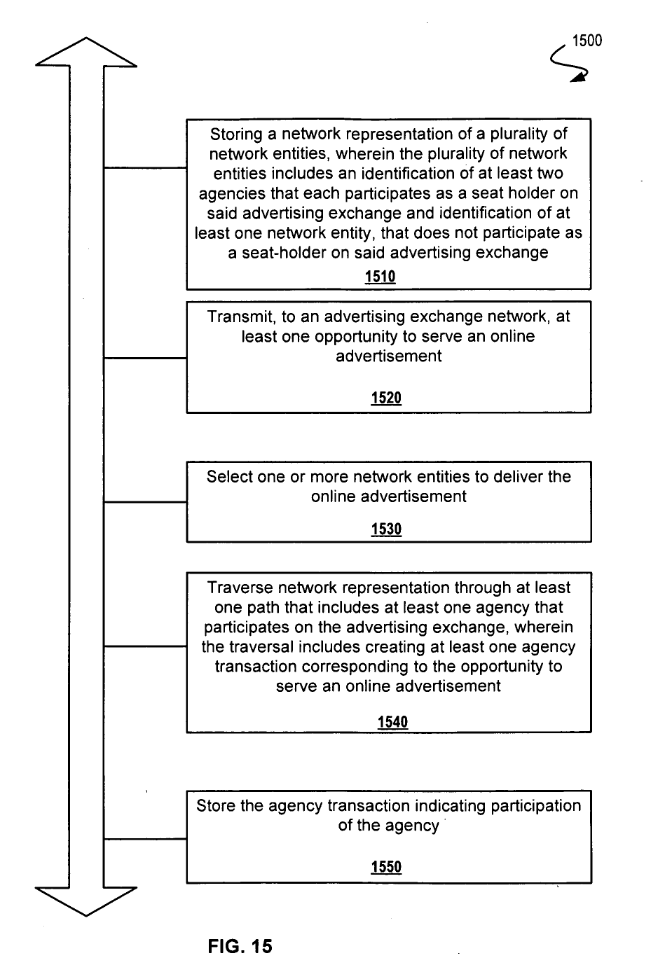

FIG. 15 is a flow chart showing operations for a method for transacting with two advertising agencies, each participating as a seat-holder on an advertising exchange. The steps might be executed in serial fashion, or they might be executed in parallel or partially serially, and partially in parallel. The embodiment shown is purely exemplary, and might be implemented in the context of one or more of FIG. 1A through FIG. 14. The embodiment of 1500 shows five operations, although this architecture is strictly exemplary, and the method for transacting with an advertising agency participating on an advertising exchange network might be implemented using fewer (or more) operations. As shown, FIG. 15. depicts a method for transacting with two advertising agencies, each participating as an exchange seat-holder on an advertising exchange network and each having a plurality of clients, at least some of which are not participating as a seat-holder on the network exchange. Accordingly the method includes steps for storing a network representation of the plurality network entities (see operation 1510), in particular, storing a network representation of at least two advertising agencies, each participating on the same advertising exchange network, and storing a network representation including at least one client who is not a seat-holder on the exchange. The method also includes steps for transmitting at least one opportunity to serve an online advertisement (see operation 1520), selecting one or more network entities to deliver said online advertisement (see operation 1530), traversing the network representation through at least one path that includes at least one seat-holder (see operation 1540), and storing the agency transaction indicating participation of the agency in the transaction (see operation 1550).

While the invention has been described with reference to numerous specific details, one of ordinary skill in the art will recognize that the invention can be embodied in other specific forms without departing from the spirit of the invention. Indeed, one of ordinary skill in the art will realize that this patent covers online media other than web pages delivered to computers, such online media including advertising on mobile phones, electronic billboards, televisions, game consoles, or other display devices, any of which may deliver textual, graphical, video, or audio media. Also, one of ordinary skill in the art will realize that techniques such as traversing a directed graph, enumerating paths, or techniques for graph edge representations are strictly exemplary of methods for evaluating agency relationships. Other techniques such as indexed stores, constraint evaluation systems, or numerical optimization systems might use data structures and algorithms in addition to or instead of those disclosed herein. Thus, one of ordinary skill in the art would understand that the invention is not to be limited by the foregoing illustrative details, but rather is to be defined by the appended claims.

We claim:

1. A method for transacting with an agency participating on an advertising exchange network having a plurality network entities, comprising:
storing a network representation of the plurality network entities, wherein the plurality of network entities includes an identification of at least one agency and identification of at least one network entity, wherein an agency participates on said advertising exchange and a network entity does not participate on said advertising exchange;
transmitting, to said advertising exchange network, at least one opportunity to serve an online advertisement;
selecting, at said advertising exchange network, one or more network entities to deliver said online advertisement;
traversing said network representation through at least one path that includes at least one network entity, wherein said traversing includes creating at least one agency transaction corresponding to the opportunity to serve an online advertisement; and
storing said at least one agency transaction indicating participation of the agency.

2. The method of claim 1 wherein the storing a network representation of the plurality network entities includes at least one of, a graph edge from an agency to an advertiser, a graph edge from an agency to a publisher.

3. The method of claim 1 wherein the storing a network representation of the plurality network entities includes at least one of, a graph edge representing an advertising contract.

4. The method of claim 1 wherein the storing a network representation of the plurality network entities includes at least one of, a graph edge representing a revenue sharing value, a graph edge representing an agency billing flag, a graph edge representing an agency payment flag.

5. The method of claim 1 wherein the storing a network representation of the plurality network entities includes at least one of, a graph edge representing a traffic contract.

6. The method of claim 1 wherein the traversing said network representation includes traversing the network representation in order to identify each revenue sharing participant.

7. The method of claim 1 wherein the traversing said network representation includes traversing the network representation through all paths from original buyer to original seller and selecting the path that yields the highest revenue for a publisher.

8. A system for transacting with an agency participating on an advertising exchange network having a plurality network entities, comprising:
a module for storing a network representation of the plurality network entities, wherein the plurality of network entities includes an identification of at least one agency and identification of at least one network entity, wherein an agency participates on said advertising exchange and a network entity does not participate on said advertising exchange;
a module for transmitting, to said advertising exchange network, at least one opportunity to serve an online advertisement;
a module for selecting, at said advertising exchange network, one or more network entities to deliver said online advertisement;
a module for traversing said network representation through at least one path that includes at least one network entity, wherein said traversing includes creating at least one agency transaction corresponding to the opportunity to serve an online advertisement; and
a module for storing said at least one agency transaction indicating participation of the agency.

9. The method of claim 8 wherein the storing a network representation of the plurality network entities includes at least one of, a graph edge from an agency to an advertiser, a graph edge from an agent to a publisher.

10. The method of claim 8 wherein the storing a network representation of the plurality network entities includes at least one of, a graph edge representing an advertising contract.

11. The method of claim 8 wherein the storing a network representation of the plurality network entities includes at least one of, a graph edge representing a revenue sharing value, a graph edge representing an agency billing flag, a graph edge representing an agency payment flag.

12. The method of claim 8 wherein the storing a network representation of the plurality network entities includes at least one of, a graph edge representing a traffic contract.

13. The method of claim 8 wherein the traversing said network representation includes traversing the network representation in order to identify each revenue sharing participant.

14. The method of claim 8 wherein the traversing said network representation includes traversing the network representation through all paths from original buyer to original seller and selecting the path that yields the highest revenue for a publisher.

15. A computer readable medium for storing instruction, which when executed by a computer, causes the computer to transact with an agency participating on an advertising exchange network having a plurality network entities, said instructions for:
transmitting, to said advertising exchange network, at least one opportunity to serve an online advertisement;
selecting, at said advertising exchange network, one or more network entities to deliver said online advertisement;
traversing said network representation through at least one path that includes at least one network entity, wherein said traversing includes creating at least one agency transaction corresponding to the opportunity to serve an online advertisement; and
storing said at least one agency transaction indicating participation of the agency.

16. The method of claim 15 wherein the storing a network representation of the plurality network entities includes at least one of, a graph edge from an agency to an advertiser, a graph edge from an agent to a publisher.

17. The method of claim 15 wherein the storing a network representation of the plurality network entities includes at least one of, a graph edge representing a revenue sharing value, a graph edge representing an agency billing flag, a graph edge representing an agency payment flag.

18. The method of claim 15 wherein the storing a network representation of the plurality network entities includes at least one of, a graph edge representing a traffic contract.

19. The method of claim 15 wherein the traversing said network representation includes traversing the network representation in order to identify each revenue sharing participant.

20. The method of claim 15 wherein the traversing said network representation includes traversing the network representation through all paths from original buyer to original seller and selecting the path that yields the highest revenue for a publisher.
